(19) United States
(12) Patent Application Publication
(10) Pub. No.: US 2025/0199265 A1
(43) Pub. Date: Jun. 19, 2025

(54) OPTICAL ELEMENT DRIVING MECHANISM

(71) Applicant: TDK TAIWAN CORP., Taoyuan City (TW)

(72) Inventors: Ying-Jen WANG, Taoyuan City (TW); Yi-Ho CHEN, Taoyuan City (TW); Ya-Hsiu WU, Taoyuan City (TW)

(21) Appl. No.: 18/979,916

(22) Filed: Dec. 13, 2024

Related U.S. Application Data
(60) Provisional application No. 63/609,529, filed on Dec. 13, 2023.

(51) Int. Cl. G02B 7/08; G02B 27/64

(52) U.S. Cl. CPC G02B 7/08; G02B 27/646

(57) ABSTRACT

An optical element driving mechanism is provided, which comprises a first movable portion, a fixed portion, and a driving assembly. The first movable portion is used for connecting an optical element. The first movable portion is movable relative to the fixed portion. The driving assembly is used for driving the first movable portion to move relative to the fixed portion.

### CROSS REFERENCE TO RELATED APPLICATIONS

This application claims priority of U.S. Provisional Patent Application No. 63/609,529 filed on Dec. 13, 2023, the entirety of which is incorporated by reference herein.

### BACKGROUND OF THE INVENTION

### Field of the Invention

The present disclosure relates to an optical element driving mechanism.

### Description of the Related Art

As technology has developed, it has become more common to include image-capturing and video-recording functions into many types of modern electronic devices, such as smartphones and digital cameras. These electronic devices are used more and more often, and new models have been developed that are convenient, thin, and lightweight, offering more choice to consumers.

Electronic devices that have image-capturing or video-recording functions normally include a driving mechanism to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY OF THE INVENTION

An optical element driving mechanism is provided in some embodiments, which includes a first movable portion, a fixed portion, and a driving assembly. The first movable portion is used for connecting an optical element. The first movable portion is movable relative to the fixed portion. The driving assembly is used for driving the first movable portion to move relative to the fixed portion.

In some embodiments, the optical element driving mechanism further includes a second movable portion corresponding to the driving assembly, the second movable portion includes a first main body made of dielectric material, and a first metal assembly comprises metal and disposed on the first main body. The driving assembly includes a first circuit assembly, and the first metal assembly corresponds to the first circuit assembly.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of the optical element driving mechanism.

FIG. 1B is an exploded view of the optical element driving mechanism.

FIG. 1C is a top view of the optical element driving mechanism.

FIG. 2A is a cross-sectional view taken along line A-A of FIG. 1C.

FIG. 2B is a cross-sectional view taken along line B-B of FIG. 1C.

FIG. 2C is a cross-sectional view taken along line C-C of FIG. 1C.

FIGS. 3A, 3B, and 3C are schematic views of some elements of the optical element driving mechanism when viewed from different directions.

FIGS. 4A and 4B are schematic views of some elements of the optical element driving mechanism when viewed from different directions.

FIGS. 5A, 5B, and 5C are schematic views of some elements of the optical element driving mechanism when viewed from different directions.

FIG. 6 is a top view of some elements of the optical element driving mechanism.

FIG. 7 is a schematic view of some elements of the optical element driving mechanism.

FIG. 8 is a schematic view of the base.

FIG. 9A is a schematic view of some elements of the optical element driving mechanism.

FIG. 9B is a schematic view of some elements of the optical element driving mechanism.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may further include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may further include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

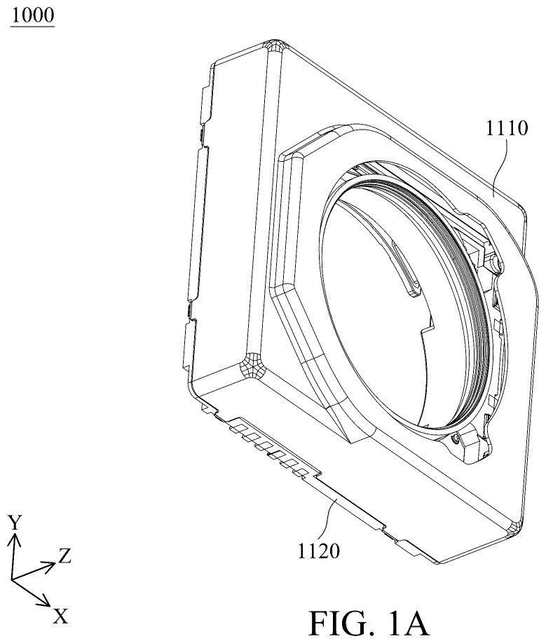

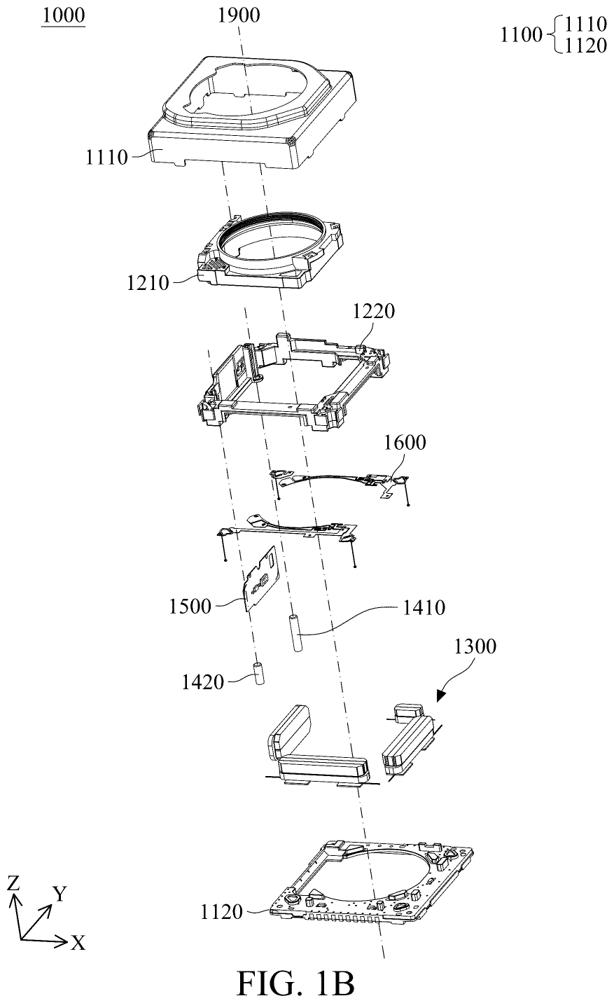

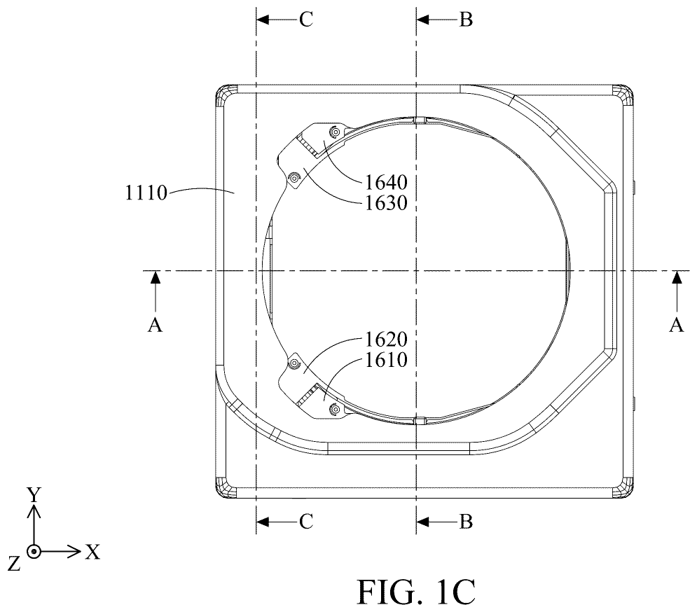

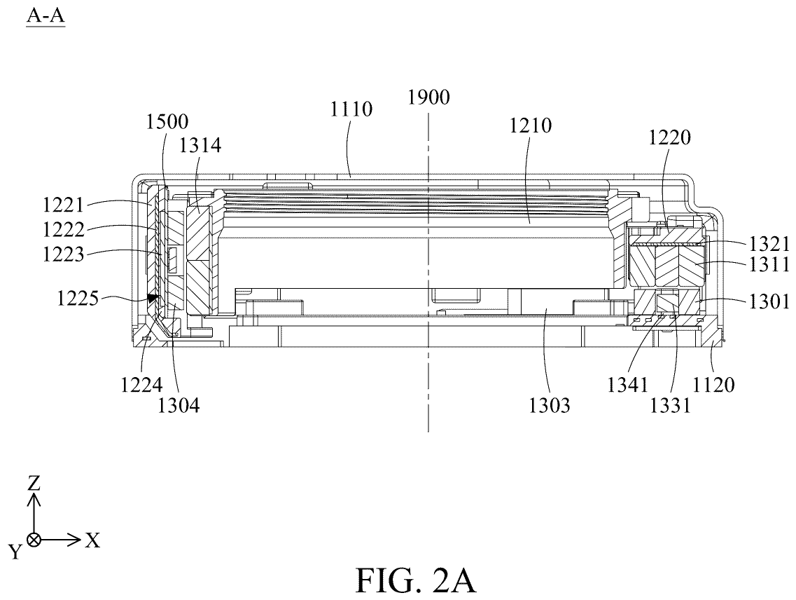

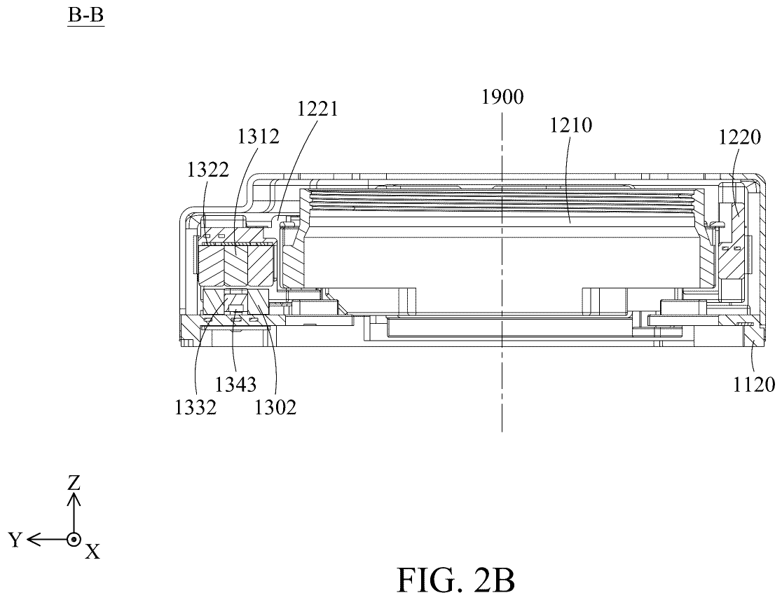

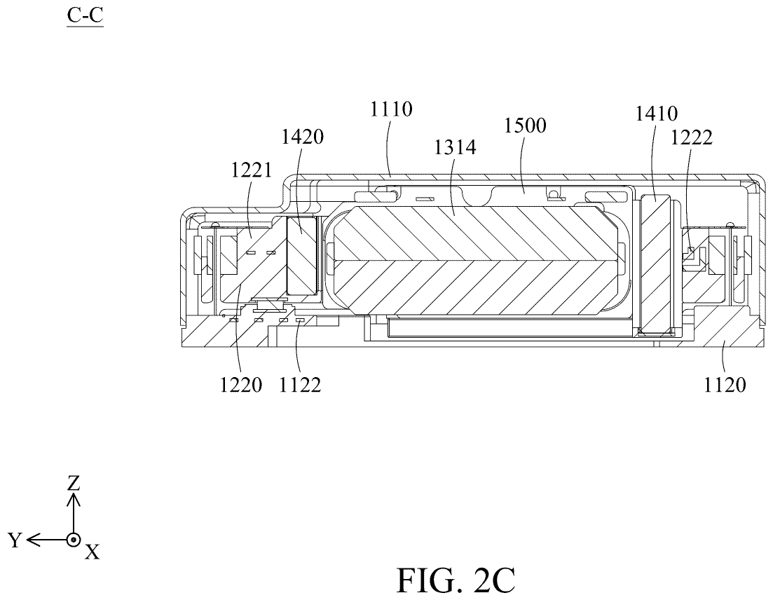

Embodiments of the present disclosure provides an optical element driving mechanism for driving an optical element to move. For example, FIG. 1A is a schematic view of the optical element driving mechanism 1000. FIG. 1B is an exploded view of the optical element driving mechanism 1000. FIG. 1C is a top view of the optical element driving mechanism 1000. FIG. 2A is a cross-sectional view taken along line A-A of FIG. 1C. FIG. 2B is a cross-sectional view taken along line B-B of FIG. 1C. FIG. 2C is a cross-sectional view taken along line C-C of FIG. 1C.

As shown in FIGS. 1A to 2C, the optical element driving mechanism 1000 may mainly include a fixed portion 1100 (including a case 1110 and a bottom 1120), a first movable portion 1210, a second movable portion 1220, a driving assembly 1300, a first intermediate element 1410, a second intermediate element 1420, a first circuit assembly 1500, and a second circuit assembly 1600 arranged along a main axis 1900, and they are used for driving the optical element (not shown) to move.

In some embodiments, the optical element may be disposed in the first movable portion 1210 and may include, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the case 1110 and the bottom 1120 of the fixed portion 1100 may be assembled to form a shell of the optical element driving mechanism 1000. Other elements of the optical element driving mechanism 1000 may be disposed within the shell formed by the case 1110 and the bottom 1120 to protect these elements. For example, the bottom 1120 may be affixed to the case 1110. In some embodiments, additional circuits may be embedded in the bottom 1120 to allow electrical connection between elements within the optical element driving mechanism 1000 and other elements.

In some embodiments, the first movable portion 1210 and the second movable portion 1220 of the movable portion 1200 may be disposed in the fixed portion 1100 and may move relative to the fixed portion 1100. In other words, the first movable portion 1210 and the second movable portion 1220 may be movably connected to the fixed portion 1100. Furthermore, the first movable portion 1210 may also move relative to the second movable portion 1220.

In some embodiments, the driving assembly 1300 may be used to drive the first movable portion 1210 and the second movable portion 1220 to move relative to the fixed portion 1100 to achieve auto focus (AF) or optical image stabilization (OIS). In some embodiments, the first movable portion 1210 may move along the Z axis, and the second movable portion 1220 may move along the X axis and Y axis.

In some embodiments, the first circuit assembly 1500 may be a printed circuit board (PCB) and may be disposed on the second movable portion 1220, such as affixed on the second movable portion 1220 by adhesion. The first circuit assembly 1500 is used to electrically connect other elements (e.g., the driving assembly 1300) within the optical element driving mechanism 1000 and external devices to provide electrical signals. This configuration controls the movement of the movable portion 1200 along the X, Y, and Z axes to achieve autofocus (AF) or optical image stabilization (OIS). The driving assembly 1300 may be fixed to the first circuit assembly 1500 by adhesion.

In some embodiments, the second circuit assembly 1600 may include metal and may be disposed between the movable portion 1200 and the fixed portion 1100 to allow the movable portion 1200 to be movably connected to the fixed portion 1100. This enables the first movable portion 1210 and the optical element disposed on the first movable portion 1210 to move relative to the fixed portion 1100. Moreover, the second circuit assembly 1600 may electrically connect to a circuit embedded in the bottom 1120 (e.g., the third metal assembly 1122, as described later) to electrically connect other electronic elements of the optical element driving mechanism 1000. For example, the second circuit assembly 1600 may include a spring plate (e.g., the first connecting portion 1610, second connecting portion 1620, third connecting portion 1630, and fourth connecting portion 1640, as described later) perpendicular to the Z axis. The spring plate may be disposed on one side of the movable portion 1200 to transmit electrical signals. In some embodiments, the second circuit assembly 1600 may be electrically connected to an external module (not shown, such as an aperture, a shutter, or other optical module) disposed on the first movable portion 1210 to move together with the first movable portion 1210 and the optical element.

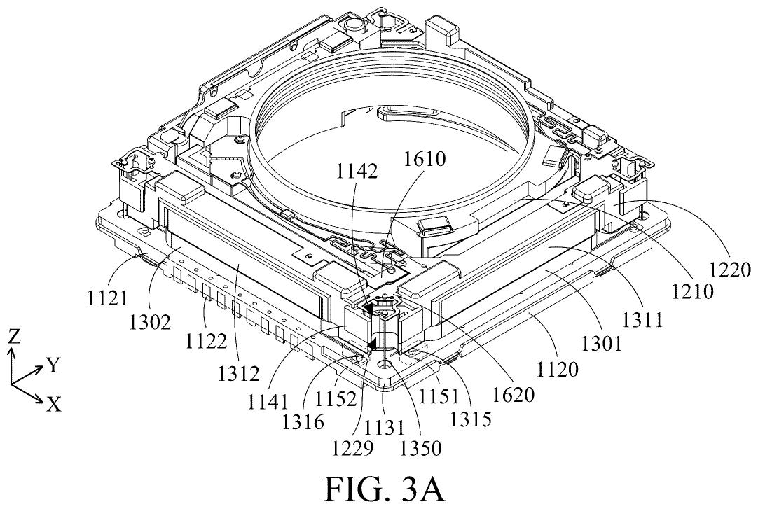

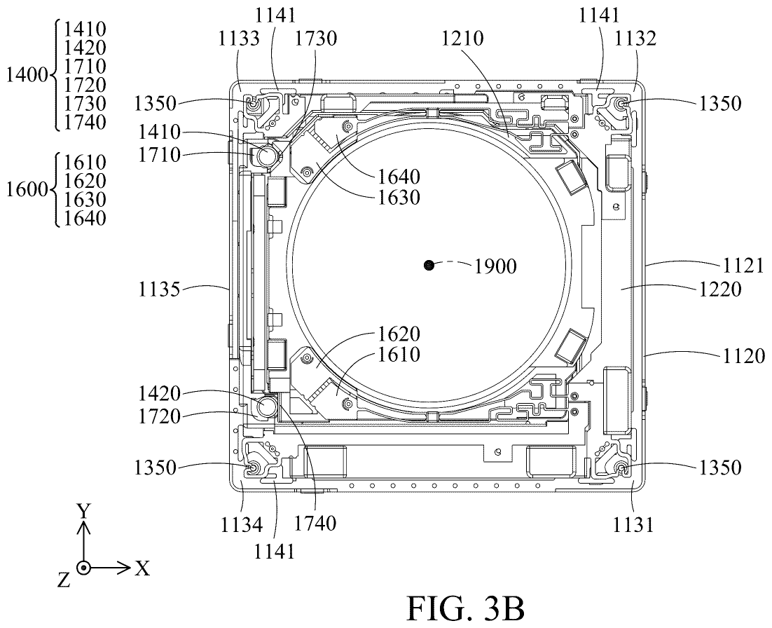

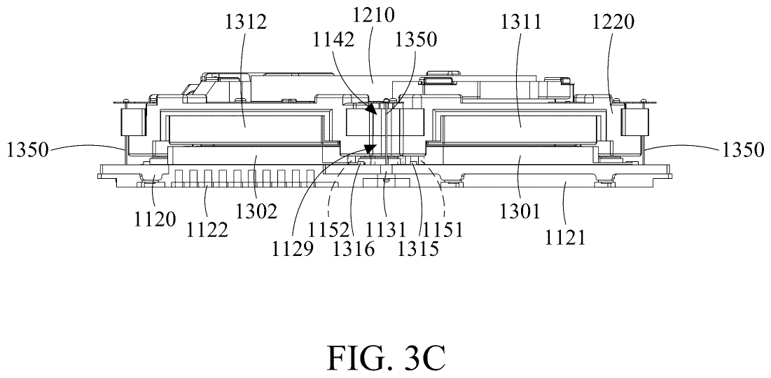

FIGS. 3A, 3B, and 3C are schematic views of some elements of the optical element driving mechanism 1000 viewed from different directions, wherein the case 1110 is omitted to show other elements. As shown in FIGS. 3A to 3C, the fixed portion 1100 (such as the bottom 1120) may have a polygonal shape with a first corner 1131, a second corner 1132, a third corner 1133, and a fourth corner 1134. A first damping element 1151 and a second damping element 1152 may be disposed at the first corner 1131, such as between the bottom 1120 and the second movable portion 1220, and they may be in direct contact with the bottom 1120 and the second movable portion 1220. This configuration absorbs vibration during movement of the first movable portion 1210 or second movable portion 1220 to achieve better optical performance. In some embodiments, the first damping element 1151 and the second damping element 1152 may include gel. The first damping element 1151 and the second damping element 1152 may also be disposed at the second corner 1132, the third corner 1133, and/or the fourth corner 1134, depending on the design requirements.

As shown in FIG. 3B, when viewed along the main axis 1900, the bottom 1120 may have a first side 1135 between the third corner 1133 and the fourth corner 1134. The second circuit assembly 1600 may include a first connecting portion 1610, second connecting portion 1620, third connecting portion 1630, and fourth connecting portion 1640, which may be disposed on the first side 1135 and aligned in a first direction (e.g., Y axis). The first connecting portion 1610, the second connecting portion 1620, the third connecting portion 1630, and the fourth connecting portion 1640 may be spaced apart from one another to prevent electrical signal interference. In some embodiments, as shown in FIG. 1C, when viewed along the main axis 1900, the first connecting portion 1610, the second connecting portion 1620, the third connecting portion 1630, and the fourth connecting portion 1640 may be at least partially exposed from the case 1110. This configuration allows an external module (not shown) to be disposed on the case 1110 and electrically connected to the optical element driving mechanism 1000 through the first connecting portion 1610, the second connecting portion 1620, the third connecting portion 1630, and the fourth connecting portion 1640.

A first stopper element 1141 may be provided at the corners of the optical element driving mechanism 1000 to limit the movement range of the first movable portion 1210 and the second movable portion 1220. For example, the second movable portion 1220 may include a first main body 1221, and the first stopper element 1141 may be affixed on the first main body 1221. The first main body 1221 and the first stopper element 1141 may include dielectric materials, and the first main body 1221 and the first stopper element 1141 may include different materials. For example, the first main body 1221 may include plastic, and the first stopper element 1141 may include rubber. In some embodiments, the Young's modulus of the first stopper element 1141 may be lower than the Young's modulus of the first main body 1221, thereby absorbing vibrations that occur when the first movable portion 1210 and the second movable portion 1220 collide with other elements.

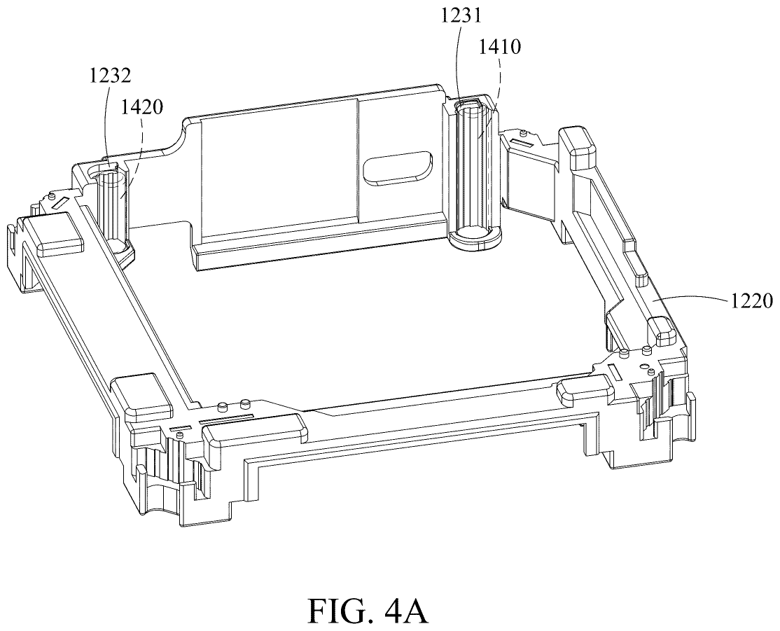

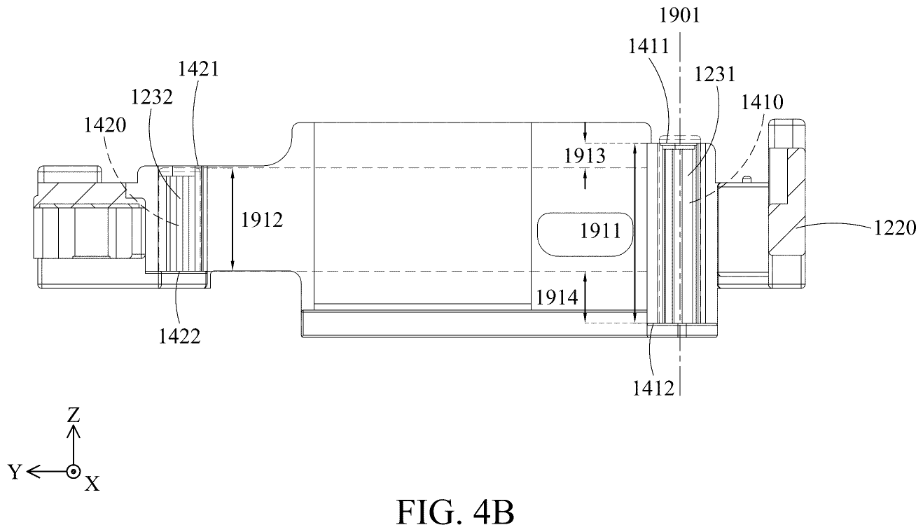

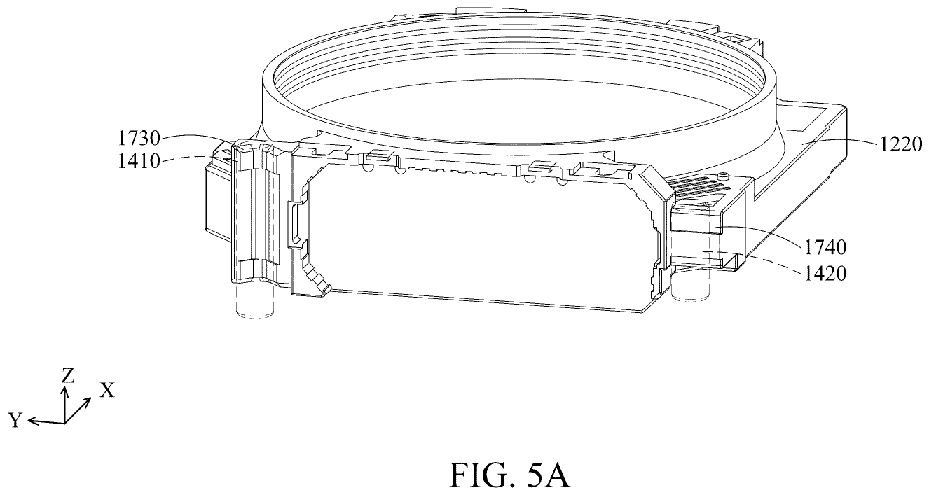

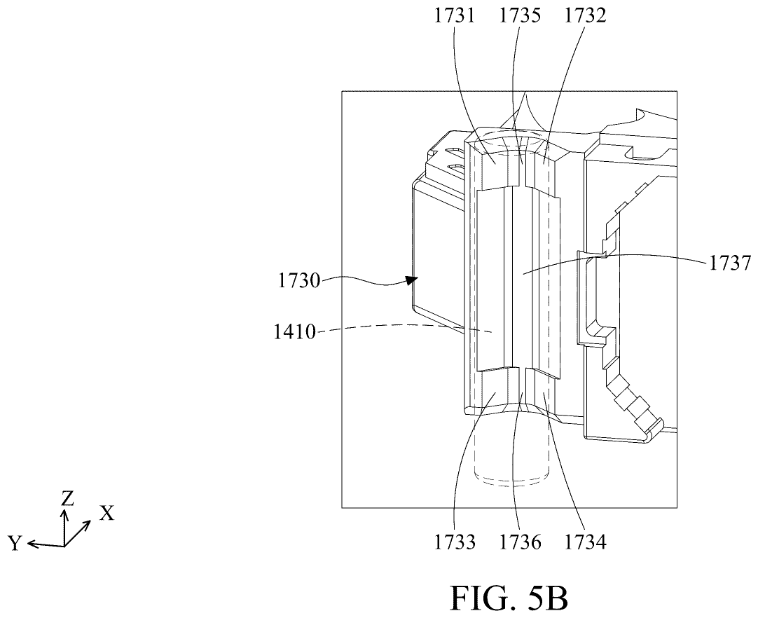

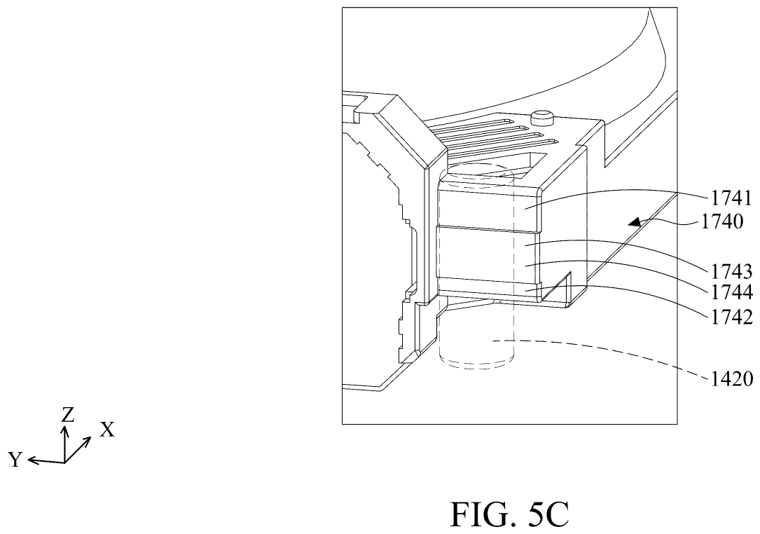

FIGS. 4A and 4B are schematic views of some elements of the optical element driving mechanism 1000 viewed from different directions, which mainly shows the positional relationship between the second movable portion 1220, the first intermediate element 1410, and the second intermediate element 1420. FIGS. 5A, 5B, and 5C are schematic views of some elements of the optical element driving mechanism 1000 viewed from different directions, mainly showing the positional relationship between the first movable portion 1210, the first intermediate element 1410, and the second intermediate element 1420.

As shown in FIGS. 2C, 3B, 4A, 4B, 5A, and 5B, the second movable portion 1220 may include a first supporting portion 1710 and a second supporting portion 1720, and the first movable portion 1210 may include a first corresponding portion 1730 and a second corresponding portion 1740. The first intermediate element 1410, the second intermediate element 1420, the first supporting portion 1710, the second supporting portion 1720, the first corresponding portion 1730, and the second corresponding portion 1740 may be collectively referred to as the supporting assembly 1400. The first movable portion 1210 is movable relative to the fixed portion 1100 through the supporting assembly 1400.

In some embodiments, the first supporting portion 1710 and the first corresponding portion 1730 may correspond to the first intermediate element 1410, and the second supporting portion 1720 and the second corresponding portion 1740 may correspond to the second intermediate element 1420. For example, the first supporting portion 1710 and the first corresponding portion 1730 may directly contact the first intermediate element 1410, and the first intermediate element 1410 may be disposed between the first supporting portion 1710 and the first corresponding portion 1730, such as in a direction that the X axis extends. Similarly, the second supporting portion 1720 and the second corresponding portion 1740 may directly contact the second intermediate element 1420, and the second intermediate element 1420 may be disposed between the second supporting portion 1720 and the second corresponding portion 1740, such as in the direction that the X axis extends.

In some embodiments, the first intermediate element 1410 and the second intermediate element 1420 may be fixed to the first supporting portion 1710 and the second supporting portion 1720, respectively, and movably connected to the first corresponding portion 1730 and the second corresponding portion 1740, respectively, via frictional contact. In other embodiments, the first intermediate element 1410 and the second intermediate element 1420 may be fixed to the first corresponding portion 1730 and the second corresponding portion 1740, respectively, and movably connected to the first supporting portion 1710 and the second supporting portion 1720, respectively, via frictional contact, depending on the design requirements. In some embodiments, the first intermediate element 1410 and the second intermediate element 1420 may have a columnar shape and extend along the Z axis. This configuration allows the first movable portion 1210 to move relative to the second movable portion 1220 along the Z axis through the supporting assembly 1400.

n some embodiments, as shown in FIGS. 4A and 4B, the second movable portion 1220 may have a first groove 1231 and a second groove 1232 used to accommodate the first intermediate element 1410 and the second intermediate element 1420, respectively. The first groove 1231 and the second groove 1232 may extend along a first axis 1901, which may be parallel to the Z axis. In some embodiments, the first intermediate element 1410 and the second intermediate element 1420 may have different lengths. For example, along the first axis 1901, the length of the first intermediate element 1410 may be greater than the length of the second intermediate element 1420. As a result, the first groove 1231 and the second groove 1232 may also have different lengths, such that the length 1911 of the first groove 1231 is greater than the length 1912 of the second groove 1232.

In some embodiments, the first groove 1231 may include a first starting end 1411 and a first ending end 1412, and the second groove 1232 may include a second starting end 1421 and a second ending end 1422. The first starting end 1411 and the first ending end 1412 may be located at opposite sides of the first groove 1231, and the second starting end 1421 and the second ending end 1422 may be located at opposite sides of the second groove 1232. Along the first axis 1901 (Z axis), there may be a non-zero gap 1913 between the first starting end 1411 and the second starting end 1421, and a non-zero gap 1914 between the first ending end 1412 and the second ending end 1422. In other words, along the first axis 1901, there may be a height difference between the first starting end 1411 and the second starting end 1421, and a height difference between the first ending end 1412 and the second ending end 1422. This configuration controls the connection relationship between the first intermediate element 1410 and the second intermediate element 1420 relative to the second movable portion 1220. For example, the connection between the first intermediate element 1410 and the second movable portion 1220 may be approximated as a two-point support, and the connection between the second intermediate element 1420 and the second movable portion 1220 may be approximated as a single-point support. This configuration provides a three-point support system, thereby enhancing the stability of the overall structure.

In some embodiments, as shown in FIG. 5B, the first corresponding portion 1730 may include a first contact surface 1731, a second contact surface 1732, a third contact surface 1733, a fourth contact surface 1734, a first connecting surface 1735, a second connecting surface 1736, and a third connecting surface 1737. The first connecting surface 1735 may be located between the first contact surface 1731 and the second contact surface 1732 and may connect the first contact surface 1731 and the second contact surface 1732. The second connecting surface 1736 may be located between the third contact surface 1733 and the fourth contact surface 1734 and may connect the third contact surface 1733 and the fourth contact surface 1734. The third connecting surface 1737 may be located between the first connecting surface 1735 and the second connecting surface 1736 and may connect the first connecting surface 1735 and the second connecting surface 1736. The first contact surface 1731, the second contact surface 1732, the third contact surface 1733, and the fourth contact surface 1734 may be spaced apart from one another.

In some embodiments, the first contact surface 1731 and the third contact surface 1733 may be arranged along the first axis 1901, and the second contact surface 1732 and the fourth contact surface 1734 may also be arranged along the first axis 1901. In some embodiments, the first intermediate element 1410 may directly contact the first contact surface 1731, the second contact surface 1732, the third contact surface 1733, and the fourth contact surface 1734 and may be spaced apart from the first connecting surface 1735, the second connecting surface 1736, and the third connecting surface 1737, such as a gap is formed therebetween. In other words, one end of the first intermediate element 1410 may directly contact the first contact surface 1731 and the second contact surface 1732, and the other end may directly contact the third contact surface 1733 and the fourth contact surface 1734. That is, along the first axis 1901, the two ends of the first intermediate element 1410 may be similar to two points leaning on the first corresponding portion 1730.

In some embodiments, as shown in FIG. 5C, the second corresponding portion 1740 may include a first buffer surface 1741, a second buffer surface 1742, a protruding portion 1743, and a fifth contact surface 1744. The protruding portion 1743 may protrude toward the second intermediate element 1420 and may be positioned between the first buffer surface 1741 and the second buffer surface 1742. The fifth contact surface 1744 may be located on the protruding portion 1743 and also positioned between the first buffer surface 1741 and the second buffer surface 1742. In some embodiments, the first buffer surface 1741, the second buffer surface 1742, and the fifth contact surface 1744 may face the second intermediate element 1420 and have normal vectors oriented in the same direction (e.g., parallel to the X axis). The fifth contact surface 1744 may directly contact the second intermediate element 1420, and the first buffer surface 1741 and the second buffer surface 1742 may be separated from the second intermediate element 1420. In this way, the second intermediate element 1420 may be approximately supported by a single point on the second corresponding portion 1740. Consequently, the first intermediate element 1410 and the second intermediate element 1420 may be supported in an approximate three-point support manner on the first movable portion 1210, thereby further enhancing the stability of the overall structure.

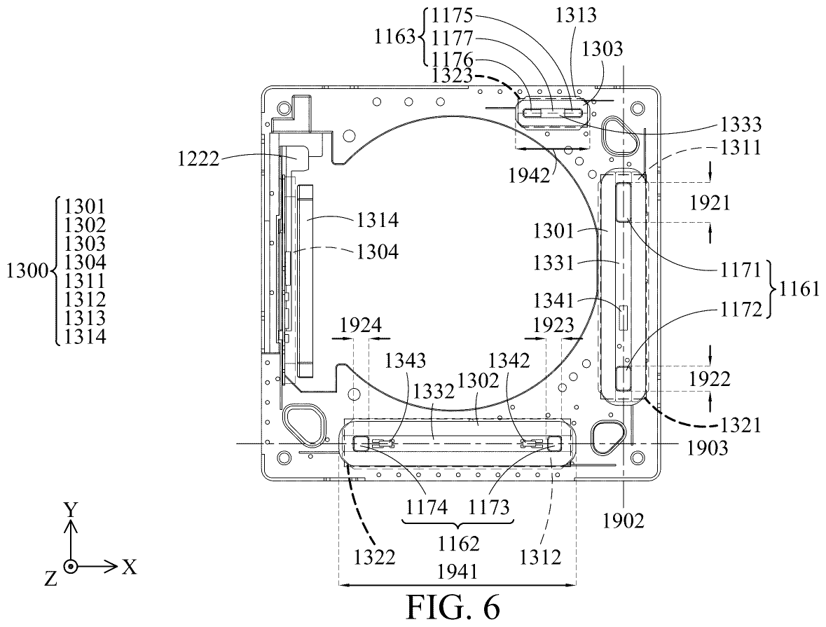

FIG. 6 is a top view of some elements of the optical element driving mechanism 1000. As shown in FIG. 6, the driving assembly 1300 may include a first coil 1301, a second coil 1302, a third coil 1303, a fourth coil 1304, a first magnetic element 1311, a second magnetic element 1312, a third magnetic element 1313, and a fourth magnetic element 1314. The first magnetic element 1311, the second magnetic element 1312, the third magnetic element 1313, and the fourth magnetic element 1314 may correspond to the first coil 1301, the second coil 1302, the third coil 1303, and the fourth coil 1304, respectively. For example, the first coil 1301, the second coil 1302, and the third coil 1303 may be aligned with the first magnetic element 1311, the second magnetic element 1312, and the third magnetic element 1313 along the Z axis, and the fourth coil 1304 may be aligned with the fourth magnetic element 1314 along the X axis.

In some embodiments, the bottom 1120 may include a first positioning portion 1161, a second positioning portion 1162, and a third positioning portion 1163. The first positioning portion 1161 may include a first positioning element 1171 and a second positioning element 1172. The second positioning portion 1162 may include a third positioning element 1173 and a fourth positioning element 1174. The third positioning portion 1163 may include a fifth positioning element 1175 and a sixth positioning element 1176. The first positioning element 1171, the second positioning element 1172, the third positioning element 1173, the fourth positioning element 1174, the fifth positioning element 1175, and the sixth positioning element 1176 may have a columnar structure and extend along the Z axis. The first coil 1301 may be wound around the first positioning element 1171 and the second positioning element 1172. The second coil 1302 may be wound around the third positioning element 1173 and the fourth positioning element 1174. The third coil 1303 may be wound around the fifth positioning element 1175 and the sixth positioning element 1176. This arrangement fixes the positions of the first coil 1301, the second coil 1302, and the third coil 1303 relative to the bottom 1120.

In some embodiments, the first positioning element 1171 and the second positioning element 1172 may be arranged along a second axis 1902 (e.g., Y axis). The third positioning element 1173 and the fourth positioning element 1174 may be arranged along a third axis 1903 (e.g., X axis), and the fifth positioning element 1175 and the sixth positioning element 1176 may be arranged along the second axis 1902 (e.g., Y axis). In other words, the first coil 1301 may have a strip-shaped structure and extend along the second axis 1902. The second coil 1302 may have a strip-shaped structure and extend along the third axis 1903. The third coil 1303 may have a strip-shaped structure and extend along the second axis 1902.

In some embodiments, along the second axis 1902, the first positioning element 1171 may have a maximum dimension 1921, and the second positioning element 1172 may have a maximum dimension 1922. Along the third axis 1903, the third positioning element 1173 may have a maximum dimension 1923, and the fourth positioning element 1174 may have a maximum dimension 1924. In some embodiments, the maximum dimension 1921 may be different from the maximum dimension 1923 and the maximum dimension 1924, and the maximum dimension 1922 may also be different from the maximum dimension 1923 and the maximum dimension 1924.

In some embodiments, as shown in FIGS. 2A, 2B, and 6, a first reinforcement element 1321, a second reinforcement element 1322, and a third reinforcement element 1323 may be disposed on the first magnetic element 1311, the second magnetic element 1312, and the third magnetic element 1313, respectively. For example, the first reinforcement element 1321, the second reinforcement element 1322, and the third reinforcement element 1323 may at least partially overlap with the first magnetic element 1311, the second magnetic element 1312, and the third magnetic element 1313 along the Z axis, respectively. Moreover, the first reinforcement element 1321, the second reinforcement element 1322, and the third reinforcement element 1323 may correspond to the first coil 1301, the second coil 1302, and the third coil 1303, respectively. For example, the first reinforcement element 1321, the second reinforcement element 1322, and the third reinforcement element 1323 may at least partially overlap with the first coil 1301, the second coil 1302, and the third coil 1303 along the Z axis, respectively. In some embodiments, winding axes of the first coil 1301, the second coil 1302, and the third coil 1303 may be parallel to the Z axis.

In some embodiments, along the Z axis, the first reinforcement element 1321 may at least partially overlap with the first positioning portion 1161, the second reinforcement element 1322 may at least partially overlap with the second positioning portion 1162, and the third reinforcement element 1323 may at least partially overlap with the third positioning portion 1163. This arrangement reduces the size of the optical element driving mechanism 1000 in other directions to achieve miniaturization. In some embodiments, the first reinforcement element 1321, the second reinforcement element 1322, and the third reinforcement element 1323 may include a material different from that of the first positioning portion 1161, the second positioning portion 1162, and the third positioning portion 1163. For example, the first reinforcement element 1321, the second reinforcement element 1322, and the third reinforcement element 1323 may include metal, and the first positioning portion 1161, the second positioning portion 1162, and the third positioning portion 1163 may include non-conductive materials such as dielectric materials like plastic or rubber.

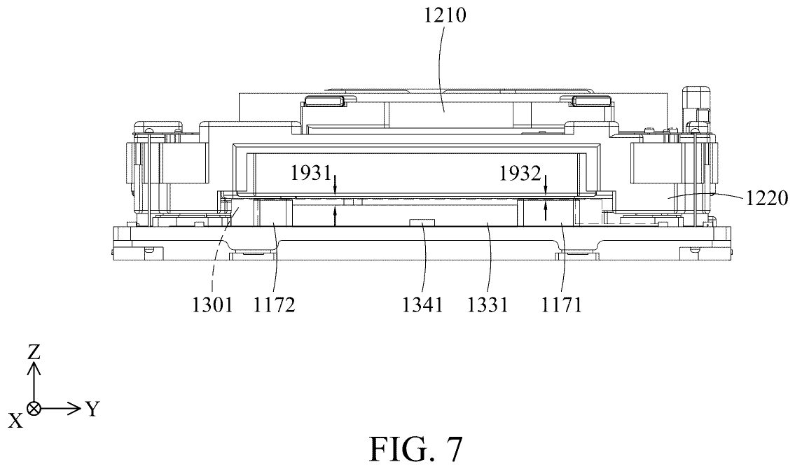

FIG. 7 is a schematic view of some elements of the optical element driving mechanism 1000. As shown in FIGS. 6 and 7, the optical element driving mechanism 1000 may further include a first electronic element 1341 disposed between the first positioning element 1171 and the second positioning element 1172. In some embodiments, the first electronic element 1341 may be, for example, a Hall sensor, a magnetoresistance effect sensor (MR sensor), a giant magnetoresistance effect sensor (GMR sensor), a tunneling magnetoresistance effect sensor (TMR sensor), or a fluxgate sensor. The first electronic element 1341 may also include an integrated circuit (IC) element for control purposes.

As shown in FIGS. 6 and 7, the optical element driving mechanism 1000 may further include a first protective element 1331 disposed between the first positioning element 1171 and the second positioning element 1172. The first protective element 1331 may directly contact the first coil 1301, the first electronic element 1341, the first positioning element 1171, and the second positioning element 1172. The first protective element 1331 may, for example, include adhesive material to fill the gaps between the first coil 1301, the first positioning element 1171, and the second positioning element 1172, and also to protect the first electronic element 1341. In some embodiments, the shortest distance 1931 between the first protective element 1331 and the first magnetic element 1311 may be greater than the shortest distance 1932 between the first positioning element 1171 and the first magnetic element 1311. This means that when the first magnetic element 1311 moves along the Z axis, the first magnetic element 1311 will first collide with the first positioning element 1171 before directly contacting the first protective element 1331. This design prevents damage to the first protective element 1331 caused by collisions with the first magnetic element 1311, thereby improving the durability of the optical element driving mechanism 1000.

In some embodiments, as shown in FIG. 6, the optical element driving mechanism 1000 may further include a second electronic element 1342 and a third electronic element 1343 disposed between the third positioning element 1173 and the fourth positioning element 1174. The second electronic element 1342 and the third electronic element 1343 may be similar to the first electronic element 1341, and therefore will not be described in detail here. A second protective element 1332 may also be provided on the second electronic element 1342 and the third electronic element 1343, such as the second protective element 1332 may be in contact with the second electronic element 1342, the third electronic element 1343, the third positioning element 1173, and the fourth positioning element 1174, thereby protecting the second electronic element 1342 and the third electronic element 1343. The second protective element 1332 may, for example, include adhesive material.

In some embodiments, as shown in FIG. 6, the third positioning portion 1163 may further include a connecting portion 1177 that connects the fifth positioning element 1175 and the sixth positioning element 1176. The connecting portion 1177 may be plate-shaped, and a third protective element 1333 may be disposed in a recess formed by the fifth positioning element 1175, the sixth positioning element 1176, and the connecting portion 1177. The third protective element 1333 may, for example, include adhesive material to protect the third coil 1303.

In some embodiments, along the third axis 1903, the maximum dimension 1941 of the second coil 1302 may be different from the maximum dimension 1942 of the third coil 1303. For example, the maximum dimension 1941 may be larger than the maximum dimension 1942. This design allows the driving force generated by the second coil 1302 and the second magnetic element 1312 to be greater than the driving force generated by the third coil 1303 and the third magnetic element 1313. As a result, the second coil 1302 and the second magnetic element 1312 may be primarily used to drive the second movable portion 1220, and the third coil 1303 and the third magnetic element 1313 may be used to prevent the second movable portion 1220 from flipping during movement.

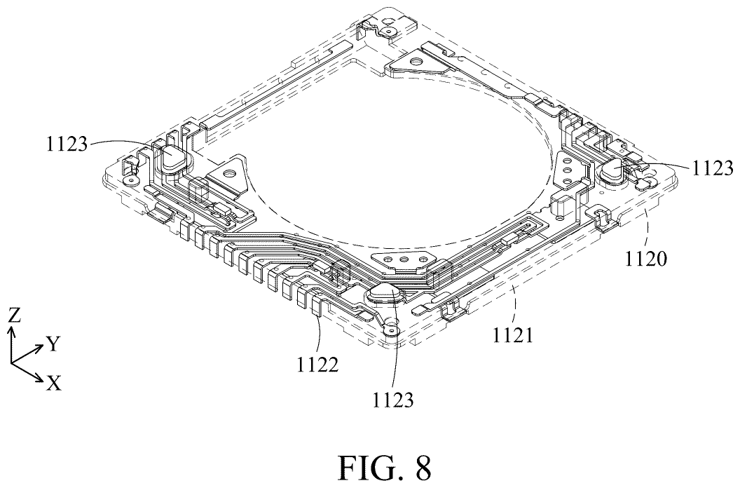

FIG. 8 is a schematic view of the bottom 1120. As shown in FIG. 8, in some embodiments, the bottom 1120 may include a second main body 1121, a third metal assembly 1122 (also referred to as a circuit unit), and a second stopper element 1123. The third metal assembly 1122 may be embedded in the second main body 1121 and partially exposed from the second main body 1121. The third metal assembly 1122 may serve as a conductive circuit as well as a structural reinforcement. The second main body 1121 may include dielectric material, such as plastic. As shown in FIGS. 3A to 3C, the first coil 1301 may be electrically connected to the third metal assembly 1122 (also referred to as a circuit unit) at a first electrical connecting portion 1315, and the second coil 1302 may be electrically connected to the third metal assembly 1122 at a second electrical connecting portion 1316. The first damping element 1151 may be in direct contact with the first electrical connecting portion 1315, and the second damping element 1152 may be in direct contact with the second electrical connecting portion 1316 to protect the first electrical connecting portion 1315 and the second electrical connecting portion 1316. The first electrical connecting portion 1315 and the second electrical connecting portion 1316 may include solder, and the third metal assembly 1122 may be partially exposed from the second main body 1121 at the first electrical connecting portion 1315 and the second electrical connecting portion 1316.

The second stopper element 1123 may be disposed on the second main body 1121 and the third metal assembly 1122 to limit the movement of the optical element, either directly or indirectly. The second stopper element 1123 may include dielectric material, and the second main body 1121 and the second stopper element 1123 may include different materials. For example, the Young's modulus of the second stopper element 1123 may be lower than the Young's modulus of the second main body 1121. In some embodiments, the second stopper element 1123 may include rubber. In some embodiments, the first stopper element 1141 and the second stopper element 1123 may include the same material, and the first main body 1221 and the second main body 1121 may also include the same material.

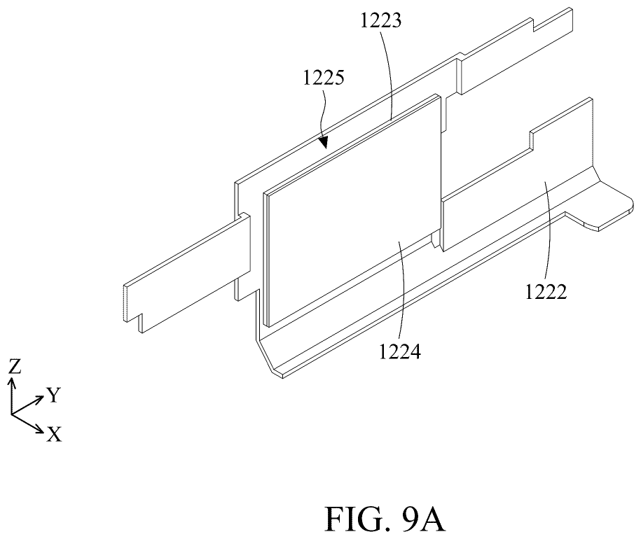

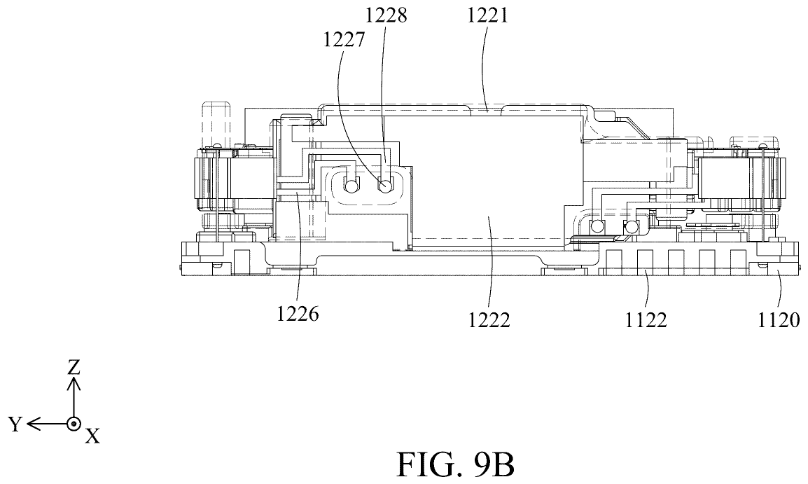

FIG. 9A is a schematic view of some elements of the optical element driving mechanism 1000. In some embodiments, as shown in FIGS. 2A and 9A, the second movable portion 1220 may further include a first metal assembly 1222 disposed in the first main body 1221. In some embodiments, the first metal assembly 1222 may include metal and may be disposed in the first main body 1221, such as may be partially embedded in the first main body 1221 and partially exposed from the first main body 1221. The first metal assembly 1222 may correspond to the first circuit assembly 1500, such as at least partial overlap each other along the X axis. The first metal assembly 1222 may be used to enhance the mechanical strength of the second movable portion 1220.

In some embodiments, the optical element driving mechanism 1000 may further include a first amplification element 1223. The first amplification element 1223 may be located between the first circuit assembly 1500 and the first metal assembly 1222 and may include metal. In some embodiments, the first metal assembly 1222 and the first amplification element 1223 may include different materials. For example, the magnetic permeability of the first amplification element 1223 may be greater than the magnetic permeability of the first metal assembly 1222, thereby increasing the driving force between the fourth coil 1304 and the fourth magnetic element 1314. As shown in FIG. 2A, the fourth coil 1304 may be disposed on the second movable portion 1220, and the fourth magnetic element 1314 may be disposed on the first movable portion 1210. The fourth coil 1304 and the fourth magnetic element 1314 may be used to drive the first movable portion 1210 to move relative to the second movable portion 1220, such as move parallel to the Z axis.

In some embodiments, as shown in FIGS. 2A and 9A, the optical element driving mechanism 1000 may further include a first connecting element 1224. The first connecting element 1224 may directly contact the first metal assembly 1222, the first amplification element 1223, and the first circuit assembly 1500. The first connecting element 1224 may include adhesive material to fix the first amplification element 1223 onto the first circuit assembly 1500. In some embodiments, the first metal assembly 1222 may have a first accommodating portion 1225, which has a recessed structure to accommodate the first amplification element 1223. The first connecting element 1224 may also be at least partially accommodated in the first accommodating portion 1225.

FIG. 9B is a schematic view of some elements of the optical element driving mechanism 1000. As shown in FIG. 9B, the second movable portion 1220 may further include a second metal assembly 1126 which includes metal. The second metal assembly 1126 may be disposed in the first main body 1221, such as partially embedded in the first main body 1221 and partially exposed from the first main body 1221. The second metal assembly 1126 may be electrically connected to the driving assembly 1300, such as may include a first electrical contact 1228 electrically connected to the driving assembly 1300 (such as electrically connected to the fourth coil 1304).

The first circuit assembly 1500 may be plate-shaped. Along a first direction parallel to the first circuit assembly 1500 (such as the Y direction), the first metal assembly 1222 and the second metal assembly 1126 may at least partially overlap each other. In addition, the optical element driving mechanism 1000 may further include a first electrical connecting element 1227 disposed on the first electrical contact 1228. For example, the first electrical connecting element 1227 overlaps the first electrical contact 1228 in the X direction. Along the first direction, the first electrical connecting element 1227 and the first metal assembly 1222 may at least partially overlap each other.

As shown in FIGS. 3A to 3C, the optical element driving mechanism 1000 may further include a third circuit assembly 1350 located at a corner of the optical element driving mechanism 1000 and extending along the Z axis. The first stopper element 1141 may have a first recess 1142 corresponding to the third circuit assembly 1350. For example, the third circuit assembly 1350 may be accommodated within the first recess 1142. The first recess 1142 may be spaced apart from the first stopper element 1141 to protect the third circuit assembly 1350. In addition, the second movable portion 1220 may also have a second recess 1229 corresponding to the third circuit assembly 1350. For example, the third circuit assembly 1350 may be accommodated within the second recess 1229. The second recess 1229 may be spaced apart from the first stopper element 1141 to protect the third circuit assembly 1350. When viewed along the main axis 1900, the first recess 1142 and the second recess 1229 may be located at the first corner 1131. In some embodiments, the first recess 1142 may be continuously connected to the second recess 1229. Since the third circuit assembly 1350 extends along the Z axis, electrical signals may be transmitted from one side of the optical element driving mechanism 1000 to the other side.

In some embodiments, the second circuit assembly 1600 may move relative to the second metal assembly 1126, and they may be electrically connected to each other. In other words, the second circuit assembly 1600, which is electrically connected to an external module (not shown), may be electrically connected to other elements through the second metal assembly 1126. The second circuit assembly 1600 may be electrically connected to the third circuit assembly 1350, and may be electrically connected to an external circuit (not shown) through the third circuit assembly 1350. The second metal assembly 1126 may also be electrically connected to the external circuit through the third circuit assembly 1350. In other words, the second metal assembly 1126 and the second circuit assembly 1600 may share the third circuit assembly 1350 to transmit signals. This design reduces the number of required elements, thereby saving costs and achieving miniaturization.

In summary, an optical element driving mechanism is provided, which includes a first movable portion, a fixed portion, and a driving assembly. The first movable portion is used for connecting an optical element. The first movable portion is movable relative to the fixed portion. The driving assembly is used for driving the first movable portion to move relative to the fixed portion. Therefore, functions such as auto focus, optical image stabilization, zooming, and miniaturization may be achieved.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. An optical element driving mechanism, comprising:
a first movable portion used for connecting an optical element;
a fixed portion, wherein the first movable portion is movable relative to the fixed portion; and
a driving assembly used for driving the first movable portion to move relative to the fixed portion.

2. The optical element driving mechanism as claimed in claim 1, further comprising a second movable portion corresponding to the driving assembly, the second movable portion comprising:
a first main body made of dielectric material; and
a first metal assembly comprises metal and disposed on the first main body;
wherein:
the driving assembly comprises a first circuit assembly, and the first metal assembly corresponds to the first circuit assembly.

3. The optical element driving mechanism as claimed in claim 2, further comprising a first amplification element disposed between the first circuit assembly and the first metal assembly;
wherein:
the first amplification element comprises metal;
the first amplification element and the first metal assembly comprise different materials;
magnetic permeability of the first amplification element is greater than magnetic permeability of the first metal assembly.

4. The optical element driving mechanism as claimed in claim 3, further comprising a first connecting element in direct contact with the first amplification element;
wherein:
the first connecting element directly contacts the first main body;
the first connecting element directly contacts the first circuit assembly;
the first connecting element directly contacts the first metal assembly.

5. The optical element driving mechanism as claimed in claim 4, wherein:
the first metal assembly comprises a first accommodating portion used for accommodating the first amplification element;
the first connecting element is at least partially accommodated in the first accommodating portion.

6. The optical element driving mechanism as claimed in claim 5, wherein:
the second movable portion further comprises a second metal assembly having metal, disposed on the first main body, and electrically connected to the driving assembly;
the first circuit assembly is plate-shaped;
the first metal assembly and the second metal assembly at least partially overlap each other in a first direction parallel to the first circuit assembly;
the second metal assembly comprises a first electrical contact connected to the driving assembly.

7. The optical element driving mechanism as claimed in claim 6, further comprising a first electrical connecting element;
wherein:
the first electrical connecting element and the first metal assembly at least partially overlap each other in the first direction;
the first electrical connecting element is disposed on the first electrical contact.

8. The optical element driving mechanism as claimed in claim 7, further comprising:
a second circuit assembly used for connecting to an external circuit; and
a third circuit assembly used for connecting to the external circuit.

9. The optical element driving mechanism as claimed in claim 8, wherein:
the second circuit assembly comprises a first connecting portion and a second connecting portion;
a gap is between the second connecting portion and the first connecting portion;
when viewed along a main axis, the optical element driving mechanism is polygonal and comprises a first side;
when viewed along the main axis, the first connecting portion and the second connecting portion are disposed on the first side.

10. The optical element driving mechanism as claimed in claim 9, wherein:
the fixed portion comprises a case and a bottom;
the case and the bottom are arranged along the main axis;
when viewed along the main axis, the first connecting portion and the second connecting portion are at least partially exposed from the case.

11. The optical element driving mechanism as claimed in claim 10, wherein:
the second circuit assembly is movable relative to the second metal assembly;
the second circuit assembly is electrically connected to the second metal assembly;
the second circuit assembly is electrically connected to the external circuit through the third circuit assembly;
the second metal assembly is electrically connected to the external circuit through the third circuit assembly.

12. The optical element driving mechanism as claimed in claim 11, wherein:
the second circuit assembly further comprises:
a third connecting portion; and
a fourth connecting portion, wherein a gap is between the third connecting portion and the fourth connecting portion.

13. The optical element driving mechanism as claimed in claim 12, wherein:
when viewed along the main axis, the third connecting portion and the fourth connecting portion are disposed on the first side;
when viewed along the main axis, the third connecting portion and the fourth connecting portion are at least partially exposed from the case;
the first connecting portion, the second connecting portion, the third connecting portion, and the fourth connecting portion are arranged in the first direction.

14. The optical element driving mechanism as claimed in claim 13, further comprising a first stopper element used for limiting movement range of the first movable portion;
wherein:
the first stopper element is affixed on the first main body;
the first stopper element comprises dielectric material;
the first stopper element and the first main body comprises different materials.

15. The optical element driving mechanism as claimed in claim 14, wherein:
Young's modulus of the first stopper element is lower than Young's modulus of the first main body;
the first stopper element comprises a first recess corresponding to the third circuit assembly;
the first stopper element is spaced apart from the third circuit assembly.

16. The optical element driving mechanism as claimed in claim 15, wherein:
the second movable portion comprises a second recess corresponding to the third circuit assembly;
the second recess is spaced apart from the third circuit assembly;
the first recess is continuously connected to the second recess.

17. The optical element driving mechanism as claimed in claim 16, wherein:
when viewed along the main axis, the optical element driving mechanism is polygonal and comprises a first corner;
when viewed along the main axis, the first recess is at the first corner; and
when viewed along the main axis, the second recess is at the first corner.

18. The optical element driving mechanism as claimed in claim 17, further comprising:
a second stopper element used for limiting the movement of the optical element;
a third metal assembly, wherein the second stopper element is disposed on the third metal assembly; and
a second main body, wherein the third metal assembly is at least partially disposed on the second main body.

19. The optical element driving mechanism as claimed in claim 18, wherein:
the second stopper element comprises dielectric material;
the second main body comprises dielectric material;
the second stopper element and the second main body comprise different materials.

20. The optical element driving mechanism as claimed in claim 19, wherein:
Young's modulus of the second stopper element is lower than Young's modulus of the second main body;
the first stopper element and the second stopper element comprise a same material; and
the first main body and the second main body comprise a same material.
